(19) United States
(12) Patent Application Publication
(10) Pub. No.: US 2023/0283834 A1
(43) Pub. Date: Sep. 7, 2023

(54) SYNCHRONOUS WIDGET AND A SYSTEM AND METHOD THEREFOR

(71) Applicant: Brandon Fischer, Carmel, IN (US)

(72) Inventor: Brandon Fischer, Carmel, IN (US)

(21) Appl. No.: 18/175,794

(22) Filed: Feb. 28, 2023

Related U.S. Application Data
(60) Provisional application No. 63/268,730, filed on Mar. 1, 2022.

(51) Int. Cl. H04N 21/431; H04N 21/2187; H04N 21/242

(52) U.S. Cl. CPC H04N 21/4312; H04N 21/2187; H04N 21/242

(57) ABSTRACT

A communication system and a computer-implemented method for providing a screenshare to multiple computing devices as a live share, and, in nonlimiting embodiments, a communication system and computer-implemented method for providing one or more of the computing devices with a capability of creating, modifying and controlling a synchronous widget in the screenshare, wherein the synchronous widget is renderable at on each participant computing device in its current real-time state, even between live share sessions.

### CROSS REFERENCE TO PRIOR APPLICATION

This application claims priority to, and the benefit thereof, provisional U.S. Patent Application Ser. No. 63/268,730, filed on Mar. 1, 2022, the entirety of which is hereby incorporated herein by reference as if fully set forth herein.

### FIELD OF THE DISCLOSURE

The present disclosure relates to a communication system and a computer-implemented method for providing a screenshare to multiple computing devices as a live share, and, more particularly, to a communication system and a computer-implemented method for providing each computing device with a capability of creating, modifying or controlling a rendering of a synchronous widget in the screenshare on one or more computing devices.

### BACKGROUND OF THE DISCLOSURE

In a computer networked environment such as the Internet, videoconferencing is commonly used for the reception and transmission of audio-video (AV) content by users in different locations, for communication between people in real-time. Videoconference systems such as, for example, ZOOM, Microsoft TEAMS, and Webex are commonly used to facilitate AV content exchange amongst multiple users. While such videoconferencing systems can provide users with an ability to live share AV content, the systems do not provide a real-world experience since users are unable to create, modify or control rendering of widgets in a live screenshare.

There exists an unfulfilled need for a communication solution that can provide a screenshare to multiple computing devices as a live share, and that can provide each computing device with a capability of creating, modifying or controlling widgets in the screenshare.

### SUMMARY OF THE DISCLOSURE

The present disclosure provides a communication solution for providing a screenshare to multiple computing devices as a live share, and, in various nonlimiting embodiments, a communication system and a computer-implemented method for providing one or more of the computing devices with a capability of creating, modifying, or controlling a synchronous widget in the screenshare.

In embodiments of the disclosure, a system and computer-implemented are constructed to provide a screenshare to one or more computing devices as a live share, wherein the parties involved in the live share can create, modify or control one or more synchronous widgets in the screenshare, including in real-time. The communication system and computer-implemented method can be configured to record and retain synchronous widgets made in the live share in a synchronized state with respect to the computing devices participating in the live share.

The communication system and computer-implemented method can be arranged to record and retain the synchronous widget as it appears in the live share, in real-time, such that the widget is synchronized across all computing devices participating in the live share.

The communication system and computer-implemented method can be arranged to retain the synchronous widget in the state it appears in the live share, such that the state of the widget can persist between a plurality of live share sessions. Accordingly, a widget can be synchronized among participant computing devices in a live share and the widget's state can persist between the live share sessions such that, for example, when a participant enters a later live share session, that participant can be presented with the widget in the same state it existed when that participant left the prior live share session, or the state of the widget as it existed the last time it was modified or manipulated in a prior live share session.

The communication system and computer-implemented method can be arranged to capture and retain information about each synchronous widget, including information necessary to render or reproduce the synchronous widget in its current, real-time state, as well as information about each live share participant that created, modified, manipulated or otherwise contributed with respect to the synchronous widget.

In an embodiment of the disclosure, a communication system is provided that initiates and maintains a screenshare comprising live audio-video (AV) content from one or more participant computing devices in a live share session. The system comprises: a receiver configured to receive a live audio-video content feed from a first participating computing device; a processor configured to: initiate, by a live share creator, a live share session that includes the live audio-video content feed from the first participating computing device and a widget; generate a screenshare, by a screenshare renderer, containing the audio-video content feed from the first participating computing device and the widget; detect, by a widget state monitor, in real time any interaction with the widget; and when an interaction with the widget occurs, record, by the widget state monitor, details of the interaction including a current real-time state of the widget; a transmitter configured to send the screenshare, including the live audio-video content feed from the first participating computing device, and a synchronous widget to a second participating computing device, wherein the synchronous widget includes the details of the interaction, including the current real-time state of the widget, and wherein the synchronous widget is maintained persistently regardless of any interruption in the live share session.

The communication system can further comprise a widget generating tool configured to generate the widget, wherein the widget is configured to interact with the first computing device or the second computing device.

The communication system can further comprise a screenshare renderer configured to generate the screenshare based on the synchronous widget and video content contained in the live audio-video content feed from the first participating computing device.

In the communication system, the screenshare renderer can be configured to communicate and interact with the transmitter to: assemble the synchronous widget and the video content into a video screenshare; packetize the video screenshare; and send the packetized video screenshare to the second participating computing device.

In the communication system, the screenshare renderer can include a translator configured to translate the video content or audio content contained in the live audio content feed from a first format or language to a second format or language used by the second participating computing device.

In the communication system the interruption in the live share session can comprise the first computing device disconnecting from the live share session and reconnecting at a later time.

In the communication system, the first computing device can be provided with the synchronous widget when reconnecting at a later time.

In an embodiment, a computer-implemented method is provided for initiating and maintaining a screenshare comprising live audio-video (AV) content from one or more participant computing devices in a live share session. The method comprises: receiving a live audio-video content feed from a first participating computing device; initiating, by a live share creator, a live share session that includes the live audio-video content feed from the first participating computing device and a widget; generating a screenshare, by a screenshare renderer, containing the audio-video content feed from the first participating computing device and the widget; detecting, by a widget state monitor, in real time any interaction with the widget; when an interaction with the widget occurs, recording, by the widget state monitor, details of the interaction including a current real-time state of the widget; and transmitting the screenshare, including the live audio-video content feed from the first participating computing device, and a synchronous widget to a second participating computing device, wherein the synchronous widget includes the details of the interaction, including the current real-time state of the widget, and wherein the synchronous widget is maintained persistently regardless of any interruption in the live share session.

The computer-implemented method can further comprise: generating the widget by a widget generating tool configured such that the widget interacts with a graphic user interface of the first computing device or the second computing device; or generating the screenshare based on the synchronous widget and video content contained in the live audio-video content feed from the first participating computing device; or assembling the synchronous widget and the video content into a video screenshare, packetizing the video screenshare, and sending the packetized video screenshare to the second participating computing device.

The computer-implemented method can further comprise translating the video content or audio content contained in the live audio content feed from a first format or language to a second format or language used by the second participating computing device.

In the computer-implemented method, the interruption in the live share session can comprise the first computing device disconnecting from the live share session and reconnecting at a later time.

In the computer-implemented method, the first computing device can be provided with the synchronous widget when reconnecting at a later time.

In an embodiment of the disclosure, a non-transitory computer-readable medium is provided for initiating and maintaining a screenshare comprising live audio-video (AV) content from one or more participant computing devices in a live share session, the computer-readable medium comprising instructions that, when executed by a processor, cause the processor to perform a method comprising: receiving a live audio-video content feed from a first participating computing device; initiating, by a live share creator, a live share session that includes the live audio-video content feed from the first participating computing device and a widget; generating a screenshare, by a screenshare renderer, containing the audio-video content feed from the first participating computing device and the widget; detecting, by a widget state monitor, in real time any interaction with the widget; when an interaction with the widget occurs, recording, by the widget state monitor, details of the interaction including a current real-time state of the widget; and transmitting the screenshare, including the live audio-video content feed from the first participating computing device, and a synchronous widget to a second participating computing device, wherein the synchronous widget includes the details of the interaction, including the current real-time state of the widget, and wherein the synchronous widget is maintained persistently regardless of any interruption in the live share session.

In the non-transitory computer-readable medium, the method can further comprise: generating the widget by a widget generating tool configured such that the widget interacts with a graphic user interface of the first computing device or the second computing device; or generating the screenshare based on the synchronous widget and video content contained in the live audio-video content feed from the first participating computing device; or assembling the synchronous widget and the video content into a video screenshare, packetizing the video screenshare, and sending the packetized video screenshare to the second participating computing device; or translating the video content or audio content contained in the live audio content feed from a first format or language to a second format or language used by the second participating computing device.

In the non-transitory computer-readable medium, the interruption in the live share session can comprise the first computing device disconnecting from the live share session and reconnecting at a later time.

Additional features, advantages, and embodiments of the disclosure may be set forth or apparent from consideration of the detailed description and drawings. Moreover, it is to be understood that the foregoing summary of the disclosure and the following detailed description and drawings provide nonlimiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure.

FIG. 1 depicts an implementation of a communication system in a user environment, arranged according to the principles of the disclosure.

FIG. 2 depicts a nonlimiting embodiment of a communication system, constructed according to the principles of the disclosure.

FIG. 3 depicts a nonlimiting embodiment of a computer-implemented method, according to the principles of the disclosure.

FIG. 4 depicts a nonlimiting example of screenshare, including a widget, according to the principles of the disclosure.

The present disclosure is further described in the detailed description that follows.

### DETAILED DESCRIPTION OF THE DISCLOSURE

The disclosure and its various features and advantageous details are explained more fully with reference to the nonlimiting embodiments and examples that are described or illustrated in the accompanying drawings and detailed in the following description. It is noted that features illustrated in the drawings are not necessarily drawn to scale, and features of one embodiment can be employed with other embodiments, as those skilled in the art will recognize, even if not explicitly stated. Descriptions of well-known components and processing techniques may have been omitted so as to not unnecessarily obscure the embodiments of the disclosure. The examples are intended merely to facilitate an understanding of ways in which the disclosure can be practiced, and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

A widget can include a computer resource configured as a control element or an element of interaction (such as, for example, a button, a touch-sensitive area, a scroll bar, or an IVR (Interactive Voice Response) command) that can be interacted with by a user on their computing device to control, manipulate, or alter content that is rendered by the computing device, such as video content displayed on a display device or sound content reproduced by speakers. The widget can include an element of a GUI that displays information or provides a specific way for a user to interact with a computer resource (such as, for example, an operating system or software application). In various embodiments, the widget can include a computer resource configured as a control element or element of interaction in a GUI that can define or control the properties of sound reproduction, in addition to video, by a computing device, including, for example, amplitude, frequency, wavelength, velocity, phase, and timbre.

In state-of-the-art collaboration systems such as, for example, video conference systems, when a live share is shared between two or more computing devices as a screenshare, the parties involved in the live share session are unable to create, modify or control a graphical user interface (GUI) widget in the screenshare to render or retain the widget in a synchronized state across the computing devices, or in a persistent state between live share sessions.

A solution to this drawback can include somehow creating a video feed of a widget and displaying that to all computing devices in the live share session. However, the participants in that solution are not able to interact directly with the widget on their respective computing devices. Instead, all interactions must be made directly to the source of the video feed and not, locally, at the computing device. Moreover, two or more interactions with the widget at the original video feed source can be made closely in time (for example, within milliseconds of each other) such that the older interaction could be received before the new interaction, thereby resulting in a widget state that is not the current real-time state.

It is a longstanding problem in state-of-the art live share technologies that, in a shared computing environment, one person's interaction with a widget can only be seen by others during a live share session. Once the participants leave the live share session, the widget is reset to a default state, or a state seen only by the participant that interacted with the widget. In various embodiments of the disclosure, the communication system, and the computer-implemented method, are configured to render a widget that can be synchronized in real-time among any or all participants and between live share sessions as a synchronous widget.

As a nonlimiting illustrative example, consider a roulette wheel widget in a gaming embodiment that's spun by one participant and rolls 00 in a screenshare during a live share session. According to the principles of the disclosure, when another participant is logged into or enters the live share session at a later time, they will be presented by the roulette wheel widget in the state left in that last interaction, namely 00.

The various embodiments of the disclosure allow one or more widgets to be synchronized among computing devices in a live share session and persist despite interruptions in the live share session. The solution can provide widgets that serve a persistent function between live share sessions, allowing information to be reliably captured and shared despite any interruptions that might occur during a live share session, or between different live share sessions. The synchronous widget, which can be persistent between sessions, improves information flow and creates a new technology to share information between users, between logins. The synchronous widget allows particular information to be shared from one live share session to the next.

In various embodiments, the synchronous widget technology provided by this disclosure, which maintains the persistent state of the widget after the last permissible interaction in a live share session, allows software developers, when creating their own widgets, to create synchronous widgets. This allows widgets to serve an important persistent function between live sessions, allowing information to be reliably captured and shared despite the interruption of a live sharing session.

In an embodiment, the synchronous widget can include a task list that can be screenshared by several participant computing devices, such as, for example, by team members on a work project. In this example, the task list can be rendered persistently in its current real-time state on all participant computing devices and any interaction with the task list by a particular participant, via the GUI of their computing device, will be captured and recorded in real time (such as, for example, the user's operation of a button or scroll bar). That interaction with the GUI can be shared, in the screenshare, on all participant computing devices, exactly as it appeared on the computing device of the participant that interacted with the widget. Each interaction with the widget by a participant computing device can be captured and recorded such that the state of that widget is kept current at all times, in real time, regardless of any interruptions in the live share session.

In this example, when a participant interacts with the GUI displaying the screenshare on their computing device, such as, for example, by highlighting a part of the screenshare via the GUI, that interaction with the GUI is captured and recorded such that the current real-time state of the widget can be shared and rendered on the screen of each participant computing device, even if the participant computing device enters the live share session long after the original interaction with the widget was made.

Accordingly, in the example with the task list, all participating computing devices in a live share session would render the synchronous widget such that the task list would appear exactly, and in its current real-time form, as it appeared on the computing device of the participant that interacted with the GUI, including the exact highlighting that was made by that participant. Should one of the participating computing devices disconnect (including the device that interacted with the widget) from the live share session and reconnect at a later time, unless further changes were made to the state of the widget in the interim, the returning computing device would be provided with the synchronous widget and caused to render the task list in its current real-time state. Each time a participant logs off and then logs into a shared collaboration session, that participant will be provided with the synchronous widget (that is, the widget in its current, real-time state), including the last permissible change made to the widget, even if that participant is the only one logged in the collaboration (or live share) session.

In various embodiments, the communication system and the computer-implemented method can be configured to provide persistence between live share sessions, including providing a screenshare comprising one or more developers, in which the participant developers can create a widget that persists over time. The synchronous widget can allow information to be shared from one live share session to the next, improving information flow and creating a new technology to share information between participants that is unaffected by interruptions to the live share session, including the departure of any or all participants from the collaboration session, including between logins of the participants to the live share session.

In an embodiment, the computer-implemented method can be included in, or as part of, a software development kit (SDK), which can include a widget tool that enables a developer to create a synchronous widget that can be synchronized across all participating computing devices in a live share session, and the real-time state of which can persist between live share sessions, such as, for example, from one live share session to the next.

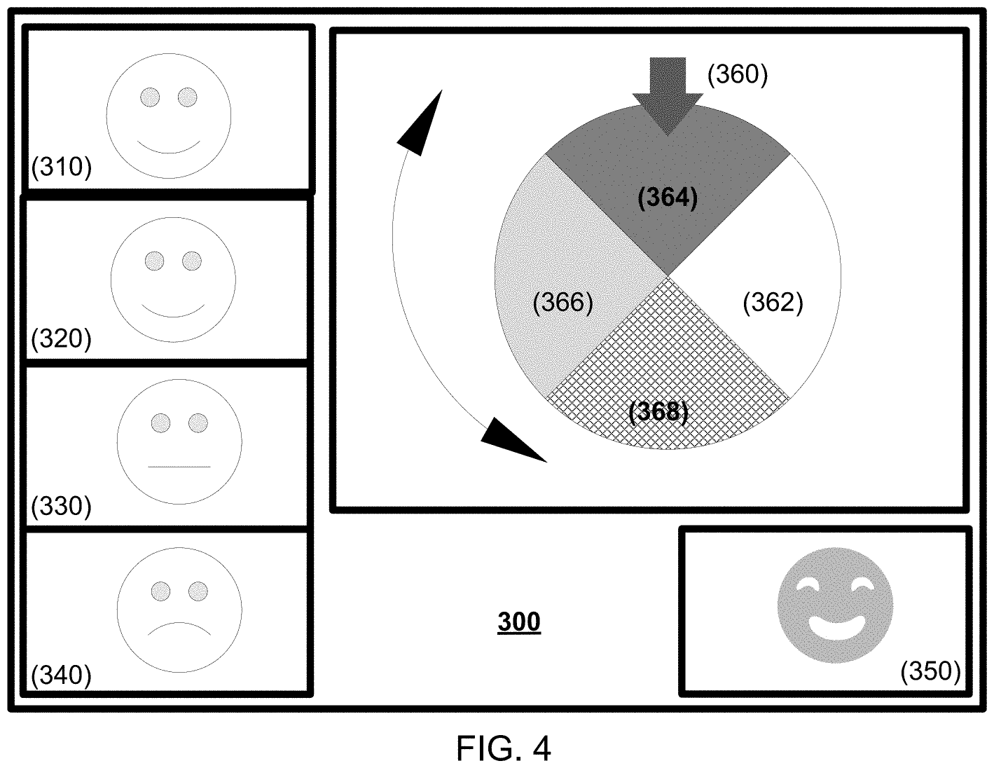

FIG. 4 depicts an illustrative, nonlimiting example of a screenshare 300 comprising live audio-video (AV) content feeds 310, 320, 330, 340, 350 and a gaming widget 360. In various embodiments, the gaming widget 360 can be generated at any of the computing devices, or at the communicating system.

In the example depicted in FIG. 4, the gaming widget 360 comprises a roulette wheel having four regions 362, 364, 366, 368, that can be spun (virtually) by any of the participants in the live share session and seen in the screenshare. The roulette wheel can be configured to spin in either direction, as denoted by a curved arrow, and stop at the location of a selector arrow, such that one of the four regions 362, 364, 366, or 368 is selected. The roulette wheel can be configured to be pivotable such that, for example, a participant can press (for example, using a mouse, a pointer, a stylus, a spoken command) an edge of the roulette wheel into the display screen and the roulette wheel can pivot 180° so that its backside (not shown) becomes visible in the screenshare, which can include, for example, a virtual poker game table. The state of the gaming widget 360 at each instant of interaction by any participant can be captured and recorded in real-time as the synchronous widget, such that it is reproduceable in its current real-time state on each participating computing device.

In this example, any of the participants 310-350 can manipulate roulette wheel, which can be operated, for example, under a random number generator (not shown), to stop at a random location. Any one or more of the participants 310-350 can leave the screenshare by disconnecting their computing device from the live share session, and the remaining participants can continue to play and spin the wheel. Then, when that computing device reconnects to the live share session, the returning participant will be presented with the most-recent, current, real-time state of the wheel—for example, in the last position at which the wheel stopped while the other participants continued to play.

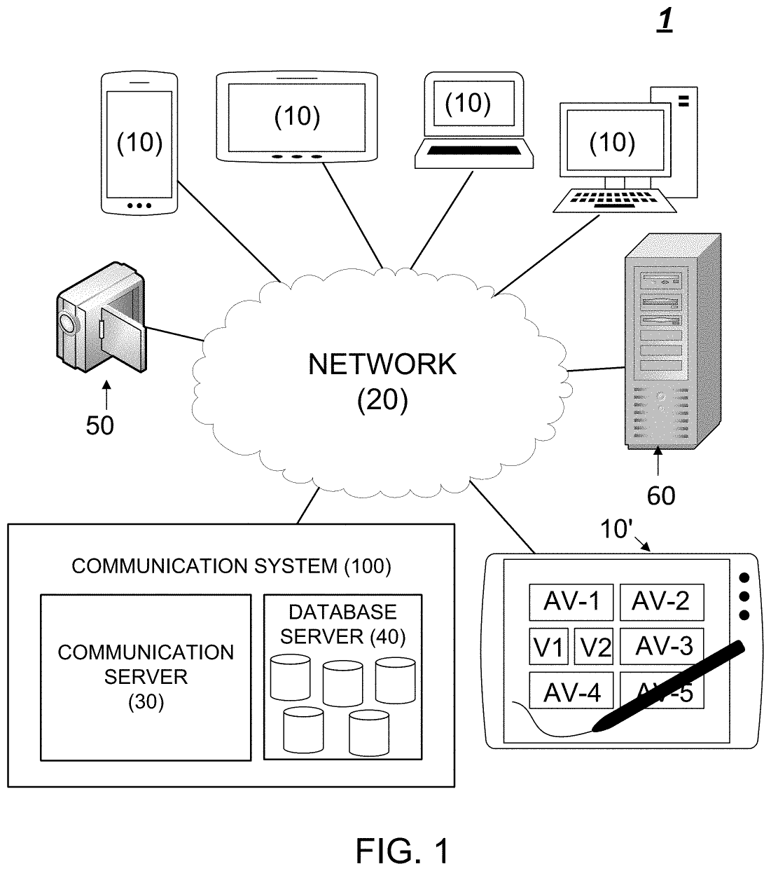

In another nonlimiting example, instead of the gaming widget 360 in FIG. 4, the widget can include a PowerPoint presentation. In various embodiments, the PowerPoint presentation can be provided separate and independent from any of the AV content feeds (for example, AV-1, AV-2, AV-3, AV-4 or AV-5, shown in FIG. 1) received from the computing devices (for example, computing devices 10, shown in FIG. 1) in the live share session, or the PowerPoint presentation can be included in any of the AV content feeds. The PowerPoint presentation can be rendered on the screen of each of the participating computing devices 10.

In this example, one of the participant computing devices (for example, computing device 10 providing the AV content feed 310) can interact with a widget for (or in) the PowerPoint presentation, for example, by altering a font or color of a word, highlighting a sentence, scrolling down (or up), or otherwise interacting with the widget to alter a portion (or a property) of the PowerPoint displayed on the display device of that particular computing device. As the participant interacts with the widget on the participant's computing device, each interaction is captured and recorded, and shared as a synchronous widget across all the participant computing devices, such that the state of the widget is always current and persistent in real-time, regardless of interruptions in the live share session, including termination of the live share session.

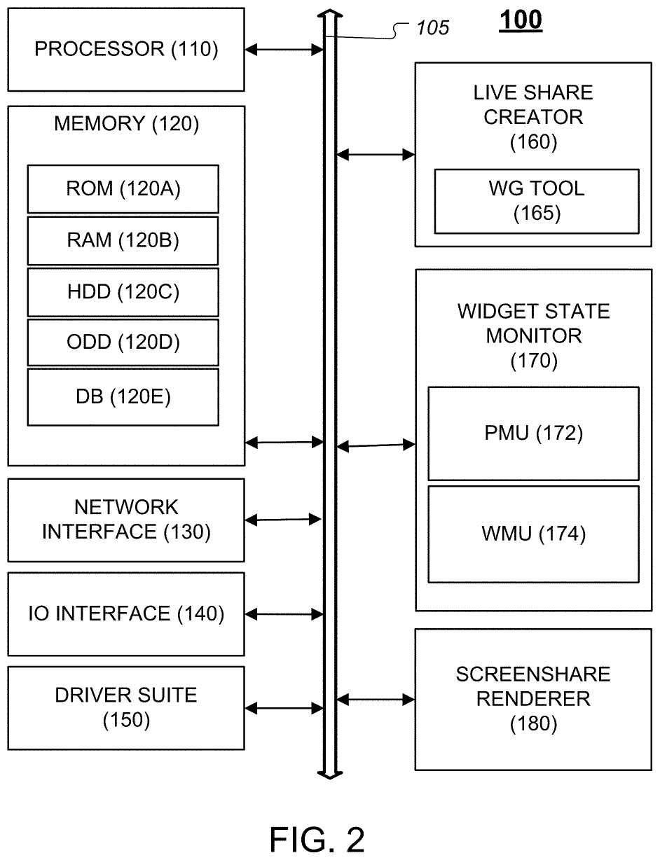

According to an embodiment, a communication system is provided that can provide synchronous widgets to one or more computing devices in a live share session. The communication system is configured to capture and record any interaction by a computing device with a GUI widget in a live share session, regardless of whether the live share session includes a single connected computing device or a plurality of connected computing devices in a screenshare. The communication system can detect any interaction with a widget by a participant (for example, using their computing device to create, modify or manipulate a widget in a screenshare) and capture and record the interaction in real-time, such that a corresponding synchronous widget is created or updated with the current real-time state of the widget. Each synchronous widget can be stored and shared with the other participating computing devices such that each respective GUI widget is rendered on those devices exactly as it appears on the computing device on which participant interacted with the widget. Each synchronous widget can be associated with a widget that was interacted with, and the corresponding screenshare or live share session. The synchronous widget can be contained in persistent storage, such as, for example, in a widget rendering file in the memory 120 (shown in FIG. 2). Thus, any computing device that connects to the live share session can be provided with the synchronous widget such that the device can render the screenshare with every widget in its current, real-time state.

In an embodiment, the communication system can be arranged to generate or update a synchronous widget in real-time for each widget that is created or interacted with by a computing device. The communication system can generate or update a widget rendering file for each synchronous widget, or a widget rendering file for the screenshare or live share session that contains all synchronous widgets for that screenshare or live share session. The widget rendering file can include widget content rendering (WCR) instructions and widget content rendering (WCR) data for each synchronous widget. The WCR instructions can include, for example, computer-executable instructions that, when executed by a computing device, cause the computing device to process the WCR data and render the synchronous widget in its current real-time state define.

In various embodiments, the WCR instructions include computer-executable instructions that, when executed by the computing device, control identification and rendering of each GUI widget reproduced by the computing device, such as, for example, in a screenshare or live share session. The WCR data can include widget rendering data such as, for example, identification of the widget, the location of the widget, dimensions of the widget, aspect ratio of the widget, and other properties that can be used to render the synchronous widget exactly as it appeared the last instant that the GUI widget was interacted with, in its current real-time state. The WCR data can define, for example, what widget is to be rendered, and where and how that widget is to be rendered on a display of a computing device. The WCR data can include, for example, the AV content properties (for example, including audio content properties or video content properties) for the widget, such that the synchronous widget can be reproduced exactly and in its current real-time state, as it appeared on the display of the computing device that last interacted with the widget.

In a nonlimiting embodiment, the widget rendering file, which includes the widget content rendering instructions and widget content rendering data, can include, for example, Hyper Text Markup Language (HTML), Cascading Style Sheets (CSS) and scripting languages such as, for example, JavaScript. The HTML code can include, for example, HTML 2, HTML 3, HTML 5, XHTML or any variation of HTML.

In various embodiments, the WCR instructions can include computer-readable instructions that, when executed by the processor running an operating system or, for example, an Internet browser, cause the computing device to render or reproduce the synchronous widget in its current, real-time state. The WCR instructions can be transmitted to each computing device in the live share session, either directly from the interacting computing device or via the communication system 100. Accordingly, the synchronous widget can be rendered in synchronization on each participant computing device in the live share session.

The WCR data can include, but is not limited to, for example, image dimensions, image aspect ratio, image shape, image layout, image location, image position, image orientation, image color, image texture, image font, hue, saturation, pixel intensity, pixel density, pixel address, resolution, annotations, or stylistic properties in two-dimensions (for example, x-y plane, where x and y are Cartesian coordinates), three-dimensions (for example, x-y-z space, where x, y, z are Cartesian coordinates; or x-y-t, where t is time), or four-dimensions (for example, x-y-z-t), and, in the case of sound content, amplitude, pitch, and timbre, to render the synchronous widget in its current state.

The widget rendering file can include, for example, an identification of the participant that made, modified, manipulated or otherwise interacted with the GUI widget (UserID), and the WCR data associated with the widget, including, for example, the particular widget, its location(s), the display/audio renderings related to the widget, the changes made to the widget, or any other data necessary to identify and reproduce or display the widget in its current, real-time state on all computing devices that are sharing the screenshare in a live share session.

The UserID can include, for example, the participant's name, username, telephone number, address, or an identification of the computing device, such as, for example, IP address, MAC address, or any other identifier that can uniquely identify a participant or the participant's computing device.

In certain embodiments, the WCR instructions can include, for example, HTML, CSS and JavaScript commands that, when executed by a processor, cause the processor to, for example, drive and control the pixels on a display device, or drive an audio output device (for example, speaker) to reproduce the particular sounds in the synchronous widget, in its current real-time state, in the screenshare on each participant's computing device. The HTML, CSS or JavaScript commands can define what widget, and how where that widget is to be rendered, including how it is to be created and appear in a screenshare, or be reproduced as a sound in conjunction with the screenshare.

In various embodiments, the communication system and the computer-implemented method can be arranged to receive the widget rendering file from, or create a widget rendering file from WCR instructions and WCR data received from a participating computing device that interacts with a widget on the GUI displayed on that device, such that that exact same widget can be reproduced in its real-time state in the screenshare of all participating computing devices.

The communication system and the computer-implemented method can be configured to record and retain WCR instructions and WCR data for each synchronous widget in each live share session, including the current, real-time state of each synchronous widget in the screenshare, including any interactions with any widget.

In an embodiment, any changes made to a synchronous widget by any computing device can be captured and recorded on the fly and rendered on the computing devices of all of the participants in the screenshare, in real-time and in synchronization. The widget can be stored and maintained in its current, real-time state at all times, regardless of any interruptions to the live share session, such as, for example, one or more, or all of the, participating computing devices joining or leaving the live share session.

In at least one embodiment, the communication system and the computer-implemented method can be arranged to encode any changes to synchronous widgets on-the-fly as they occur in real-time. The changes can be encoded into the screenshare, such that, for example, any newly entering participant computing device to the screenshare can render or reproduce the synchronous widget in its current, real-time state. In an embodiment, the current, real-time state of the synchronous widget, including, for example, shape, size, color, hue, saturation, intensity, pixel density, resolution, pixel address, texture, layout, font, special effect, amplitude, pitch, timbre or other characteristics and properties, can be encoded on-the-fly in a widget rendering file at the computing device that interacts with the widget and transmitted to all other participant computing devices. In at least one embodiment, the widget rendering file can be transmitted to each of the other participant computing devices via the communication system 100 (shown in FIG. 1).

FIG. 1 shows a block diagram depicting an implementation of an embodiment of a communication system 100 in an environment 1. The environment 1 can include, in addition to the communication system 100, a plurality of computing devices 10 and a network 20. The environment 1 can include a sound (audio) and image (video) pickup device 50, which can include, for example, a still camera, a video camera, a smartphone camera, or any computing device capable of capturing and transmitting a still image signal, a moving image signal, and a sound signal. The environment 1 can include a live AV content feed computer resource asset 60, such as, for example, a communication server of a multimedia content provider. The computer resource asset 60 can include a source of live AV content feed, such as, for example, a sporting match, a live classroom lecture, a tutorial, a webpage, a document or any item or thing that can be displayed or reproduced in a screenshare by one or more of the computing devices 10 during a live share session.

The computing device 10 can include, or it can be coupled to, an audio-video (AV) pickup device such as, for example, a high-definition video camera and microphone, to capture sound and video in proximity to the computing device 10, such as speech and images (for example, still or moving images) of the participant. The computing device 10 can include a communicating device such as, for example, a cellphone, a smartphone, a computer tablet, a laptop computer, a desktop computer, a workstation, or any communicating device capable of rendering one or more live AV content feeds. In the illustrated example, the live AV content feeds include AV-1, AV-2, AV-3, AV-4 or AV-5, each of which can originate from a unique computing device 10.

In a nonlimiting embodiment, any of the AV content feeds AV-1, AV-2, AV-3, AV-4, or AV-5, can be configured to include a widget rendering file that includes WCR instructions and WCR data that can be used by the other computing devices to reproduce one or more synchronous widgets. In various embodiments, the WCR data and instructions can be used by the communication system 100 or any of the computing devices 10 to render (or reproduce) the synchronous widget in a screenshare (for example, synchronous widget 360, shown in FIG. 4).

The computing device 10 can be arranged to render sound and video content received from the computer resource asset 60, such as, for example, video content V1 and V2. The sound and video content can be provided in the screenshare received from the communication system 100.

In the embodiment depicted in FIG. 1, the communication system 100 includes a communication server 30 and a database server 40. In another embodiment, the communication system 100 can include a communication device architecture, such as, for example, depicted in FIG. 2.

FIG. 2 shows a block diagram depicting an embodiment of the communication system 100. The communication system 100 can include a plurality of computer resource assets, including a bus 105, a processor 110, a memory 120, a network interface 130, an input-output (10) interface 140, a driver suite 150, a live share creator 160, a widget state monitor 170, and a screenshare renderer 180. Any of the computer resources assets 110 to 180 can be interconnected using various buses, and can be mounted on a common motherboard or in another manner, as appropriate.

The processor 110 can be arranged to process instructions for execution within the communication system 100, including instructions stored in the memory 120. The processor 110 can be arranged to generate and send, or display, graphical information for a graphic user interface (GUI) on a display screen, including, for example, an external input/output computer resource asset, such as, for example, the computing device 10 (shown in FIG. 1), which can be coupled to the communication system 100 via a communication link such as, for example, over the network 20. The processor 110 can be arranged to generate and send, or reproduce, sound information for a sound output device, such as, for example, a speaker or a voice response unit (VRU).

In various embodiments, multiple processors or multiple buses can be used, as appropriate, along with multiple memories and types of memory. The communication system 100 can be connected with any computer resource asset in the environment 1 (shown in FIG. 1) and arranged to provide portions of the necessary operations (for example, as a server bank, a group of blade servers, or a multi-processor system).

The processor 110 can include any of various commercially available processors. The processor 110 can include a computing device. Dual microprocessors and other multi-processor architectures can be employed as the processor 110. The processor 110 can include a central processing unit (CPU) or a graphic processing unit (GPU). The processor 110 can be arranged to interact with any of the computer resource assets in the communication system 100 to carry out or facilitate with the processes described herein.

The bus 105 can include any of several types of bus structures that can further interconnect to a memory bus (with or without a memory controller), a peripheral bus, and a local bus using any of a variety of commercially available bus architectures.

The memory 120 can include a read-only memory (ROM) 120A, a random-access memory (RAM) 120B, a hard disk drive (HDD) 120C, an optical disk drive (ODD) 120D, and a database (DB) 120E. The memory 120 can provide nonvolatile storage of data, data structures, and computer-executable instructions, and can accommodate the storage of any data in a suitable digital format. The memory 120 can include a computer-readable medium that can hold executable or interpretable computer code (or instructions) that, when executed by the processor 110, cause the steps, processes and methods in this disclosure to be carried out. The computer-readable medium can be contained in the memory 120, and can include sections of computer code that, when executed by the processor 110, cause the communication system 100 to render a synchronous widget and record the current real-time state of the synchronous widget, including information to render or reproduce the synchronous widget in a screenshare.

A basic input-output system (BIOS) can be stored in the ROM 120A, which can include, for example, a non-volatile memory, an erasable programmable read-only memory (EPROM), or an electrically erasable programmable read-only memory (EEPROM). The BIOS can contain the basic routines that help to transfer information between any one or more of the computing resource assets in the communication system 100, such as during start-up.

The RAM 120B can include dynamic random-access memory (DRAM), a synchronous dynamic random-access memory (SDRAM), a static random-access memory (SRAM), a nonvolatile random-access memory (NVRAM), or another high-speed RAM for caching data.

The HDD 120C can include, for example, an enhanced integrated drive electronics (EIDE) drive, a serial advanced technology attachments (SATA) drive, or any suitable hard disk drive for use with big data. The HDD 120C can be configured for external use in a suitable chassis (not shown).

The ODD 120D can be arranged to read or write from or to a compact disk (CD)-ROM disk (not shown), or, read from or write to other high capacity optical media such as a digital versatile disk (DVD).

The HDD 120C or ODD 120D can be connected to the bus 105 by a hard disk drive interface (not shown) and an optical drive interface (not shown), respectively. The hard disk drive interface (not shown) can include a Universal Serial Bus (USB) (not shown), an IEEE 1394 interface (not shown), and the like, for external applications.

The DB 120E can include one or more databases, including, for example, one or more relational databases. The DB 120E can store machine learning (ML) training datasets and ML testing datasets for building and/or training a machine learning (ML) model. In an embodiment, the communication system 100 can include a machine learning platform that can be configured to build a machine learning model and train the ML model to perform the operations disclosed herein. The ML model can be trained to detect and identify, on the fly and in real-time, a synchronous widget and generate widget rendering instructions and widget data such that the synchronous widget can be rendered or reproduced in its current real-time state, regardless of when a participant computing device logs into or accesses the screenshare comprising the synchronous widget. The ML model can be loaded, for example, into the RAM 120B, and run by the processor 110 executing computer resource processes on the ML platform. The training datasets can be updated periodically (or continuously) with updated parametric values, such as, for example, during parametric tuning of the ML model.

The memory 120 can be arranged to provide mass storage, for example, in the DB 120E. The memory 120 can include the database server storage 40 (shown in FIG. 1). The memory 120 can contain a computer-readable medium, such as a solid-state drive (SSD), a hard disk device, an optical disk device, a flash memory or other similar solid-state memory device, or an array of devices, including devices in a storage area network or other configurations.

A computer program product can be tangibly embodied in a non-transitory computer-readable medium, which can be contained in the memory 120. The computer program product can contain instructions that, when executed by a processor, cause the computing device to perform one or more methods or operations, such as those included in this disclosure. The computer-readable medium can include an information carrier such as the memory 120 or memory on processor 110.

Any number of computer resources can be stored in the memory 120, including, for example, a program module, an operating system, an application program, an application program interface (API), or program data. The computing resource can include an API such as, for example, a web API, a simple object access protocol (SOAP) API, a remote procedure call (RPC) API, a representation state transfer (REST) API, or any other utility or service API. Any (or all) of the operating system, application programs, APIs, program modules, and program data can be cached in the RAM 120B as executable sections of computer code.

The API can include an API for a markup language such as, for example, SGML, SVG, HTML, XHTML/XML), XUL, or LaTeX.

The API can include an API for a style sheet language, such as, for example, CSS, DSSSL, or XSL. The API can include a web-based API, an operating system API, a database system API, a computer hardware API, or a library API. The API can include, for example, one or more of the APIs available at <<https://developers.google.com>>.

The API can include one or more APIs that connect webpages to scripts or programing languages, including modelling (for example, SGML, SVG, HTML, XHTML/XML, XUL) documents as objects.

The API can include a document object model (DOM) API, such as for HTML or XML (for example, DOM5 HTML), that can create object-oriented representations of AV content that can be modified with a scripting module (not shown). A DOM can include a cross-platform and language-independent convention for representing and interacting with objects in HTML, XHTML/XML, SGML, SVG, or XUL.

The network interface 130 can be connected via a communication link to the network 20 (shown in FIG. 1), which can include the Internet. The network interface 130 can include a wired or a wireless communication network interface (not shown) or a modem (not shown). When used in a local area network (LAN), the communication system 100 can be connected to the LAN network through the wired or wireless communication network interface; and, when used in a wide area network (WAN), the communication system 100 can be connected to the WAN network through the modem. The modem (not shown) can be internal or external and wired or wireless. The modem can be connected to the system bus 105 via, for example, a serial port interface (not shown). The network interface 130 can include a receiver (not shown), a transmitter (not shown) or a transceiver (not shown).

In various embodiments, the transceiver (transmitter and receiver) can be communicatively coupled to the screenshare renderer 180 and configured to communicate and interact with the screenshare renderer 180 to assemble a synchronous widget and video content from any of the participant computing devices into a video screenshare, packetize the video screenshare, and send the packetized video screenshare to the any one or more of the participating computing devices.

In various embodiments, the transceiver can be communicatively coupled to the processor 110 and configured to interact with the processor 110, including to exchange computer-executable instructions and data.

The input-output (IO) interface 140 can receive commands or data from an operator via a user interface (not shown), such as, for example, a keyboard (not shown), a touch-display (not shown), a mouse (not shown), a pointer (not shown), a stylus (not shown), an interactive voice response (IVR) system (not shown), a microphone (not shown), a speaker (not shown), or a display device (not shown). The received commands and data can be forwarded from the IO interface 140 as instruction to data signals, via the bus 105, to any of the computer resource assets in the communication system 100.

The driver suite 150 can include an audio driver (not shown) and a video driver (not shown). The audio driver can include a sound card, a sound driver (not shown), an interactive voice response (IVR) unit or voice response unit (VRU), or any other computer resource capable of producing, or causing to be produced, a sound signal on a sound production device (not shown), such as for example, a speaker (not shown). The video driver can include a video card (not shown), a graphics driver (not shown), a video adaptor (not shown), or any other device necessary to render an image signal on a display device (not shown). The live share creator 160 can be arranged to initiate and create a screenshare or a live share session, such as, for example, in response to receiving a live share request from a computing device 10.

The live share creator 160 can be arranged to interact (for example, via the network interface 130) with one or more computing devices 10 to create a live share session, including sending or receiving a widget rendering file or other audio-video (AV) content rendering instructions and data that, when executed by, for example, a browser on any of the computing devices 10 (shown in FIG. 1), causes the device to render and display a screenshare, including live AV content feeds and any synchronous widgets on the display of the device.

In an embodiment, the live share creator 160 can be arranged to assemble the live AV content feeds AV-1, AV-2, AV-3, AV-4, AV-5, V1 or V2 (shown in FIG. 1) from each computing device participating in a live share session into a screenshare, including any synchronous widgets that might be created, modified or manipulated by any of the computing devices, and transmit the screenshare to the participating computing devices 10. The screenshare content can be assembled and packetized based on, for example, an RTP (Real-Time Transport), UDP (User Datagram Protocol) or IP (Internet Protocol) protocol stack and sent to each participating computing device 10.

The live share creator 160 can include, or it can be configured to be responsive to, a widget generator tool (WG Tool) 165. The widget generator tool 165 can be arranged, in an embodiment, to create widgets that can be interacted with in real-time and on-demand at the request or instruction of a participating computing device 10. For instance, the widget generator tool 165 can be arranged to create, for example, the roulette wheel (widget 360, shown in FIG. 4), such that the widget can be spun or otherwise manipulated in the x-y plane (where x, y are Cartesian coordinates), the x-y-z space (where x, y, z, are Cartesian coordinates in a three-dimensional space), or the x-y-z space (where, x, y, z, are Cartesian coordinates and t is time in a four-dimensional space) of the screenshare.

The widget state monitor 170 can be arranged to monitor and record each interaction with each widget in a screenshare, in real-time, as it is occurring during a live share session. In various embodiments, the widget state monitor 170 can be configured to communicate with each computing device in a session and monitor and record, either locally at the computing device or centrally at the communication system 100, any interactions with a widget on the screenshare. The widget state monitor 170 can be configured to generate or update a widget rendering file, or to receive a widget rendering file from the computing device that it generates or updates, based on the widget interaction and transmit the widget rendering file to the other computing devices connected to the live share session.

In an embodiment, the widget state monitor 170 can be configured to monitor and record a source identifier and the widget details for each synchronous widget, including a source identifier for each modification or manipulation of the synchronous widget. In an embodiment, the source identifier can include a participant identifier UserID of the participant or computing device 10 that created, modified or manipulated the synchronous widget, and the widget details can be contained in the WCR data in the widget rendering file. The widget state monitor 170 can include a participant management unit (PMU) 172 and a widget management unit (WMU) 174.

The PMU 172 can include a computer resource asset arranged to identify and track the identity and action of each participating computing device 10 (including, thereby, the participant) for each widget in the screenshare during a live share session. The PMU 172 can be arranged to identify each participant computing device 10 based on, for example, the UserID, and populate the widget rendering file for each synchronous widget with the identity of the computing device 10 that interacted with the widget.

The WMU 174 can include a computer resource asset arranged to detect, monitor and record, on-the-fly and in real-time, a synchronous widget as it is created, modified or manipulated in the screenshare. In an embodiment, the WMU 174 can be configured to capture and record the WCR data for each widget that is interacted with by a computing device 10, including any audio-video content data of the synchronous widget, and any changes made thereto in real-time. The WMU 174 can interact with the PMU 172 to associate each synchronous widget with the identity of the participant computing device that interacted with underlying widget, in real-time.

The WMU 174 can be arranged to capture and record the current, real-time state of each synchronous widget in the screenshare. The WMU 174 can be configured to record WCR instructions and WCR data for each synchronous widget in the screenshare. The WMU 174 can be configured to record (or generate) a widget rendering file, including the WCR instructions and data, for each synchronous widget, or for the entire screenshare. As noted previously, the widget rendering file can include UserID data for each widget. The WMU 174 can be configured to update the widget rendering file on a continuous basis, in real-time, without any lag.

The machine learning (or ML) platform can include a machine learning system such as, for example, a Word2vec deep neural network, a convolutional architecture for fast feature embedding (CAFFE), an artificial immune system (AIS), an artificial neural network (ANN), a convolutional neural network (CNN), a deep convolutional neural network (DCNN), region-based convolutional neural network (R-CNN), you-only-look-once (YOLO), a Mask-RCNN, a deep convolutional encoder-decoder (DCED), a recurrent neural network (RNN), a neural Turing machine (NTM), a differential neural computer (DNC), a support vector machine (SVM), a deep learning neural network (DLNN), Naive Bayes, decision trees, logistic model tree induction (LMT), NBTree classifier, case-based, linear regression, Q-learning, temporal difference (TD), deep adversarial networks, fuzzy logic, K-nearest neighbor, clustering, random forest, rough set, or any other machine intelligence capable of supervised or unsupervised learning for creating, modifying, manipulating or analyzing synchronous widgets. The ML model can be downloaded to any one or more of the computing devices 10 by the communication system 100. The ML model can be built and trained to detect and record any interaction with a widget by the computing device, generate or update a widget rendering file for that widget, and transmit the widget rendering file to the other computing devices 10, either directly or via the communication system 100.

The widget state monitor 170 can be arranged to capture and store the current, real-time state of each synchronous widget in memory 120, for example, as one or more widget rendering files and keep the rendering files in persistent storage until the state of any synchronous widget in the rendering files is updated, at which time the widget rendering file is updated with the new state of the synchronous widget, so that the current real-time state of each synchronous widget is persistently maintained.

The screenshare renderer 180 can be arranged to render and (via the transmitter) transmit a screenshare, including WCR instructions and WCR data (including, for example, UserID) for each synchronous widget, to each computing device 10 participating in the screenshare. The screenshare renderer 180 can be configured to receive a request from a participant (via the participant's computing device 10) and send WCR instructions and WCR data in the screenshare, such that the WCR instructions and WCR data can be processed by each participating computing device 10 to render the synchronous widget in its current, real-time state, and synchronized on all of the participant computing devices 10.

In an embodiment, the screenshare renderer 180 can be configured to translate AV content received in a first format or language from any of the computing devices 10, in real-time, to AV content in a second, different format or language. For instance, AV content can be received in French from a computing device 10 operated by a French participant and translated by the screenshare renderer 180 to English, such that an English translation of the French AV content can be included with, or substituted therefor when it is sent to another computing device 10 operated by an English speaker, such that the translated AV content will be rendered. In this embodiment, the DB 120E can include one or more language or format libraries that can be used to translate between any of the world languages, and the screenshare renderer 180 can include a language or format translator that can interact with the DB 120E and translate AV content from language or format into a second language or format. In the case of video content, the screen renderer 180 can include optical recognition software to recognize text in the video content, as well as the language of that text.

In an embodiment, the communication system can be arranged to allow a participant, during a live share, to create, modify or manipulate a synchronous widget in a screenshare and have the creation, modification or manipulation carried over, on-the-fly and in real-time, to each participant computing device. The communication system can be arranged to record the current, real-time state of the synchronous widget at all times, such that the synchronous widget can be rendered in its current, real-time state, regardless of when the screenshare is accessed or rendered by a computing device 10, including, for example, when it is accessed in a later, different live share session.

The communication system 100 can be arranged to encode the current, real-time state of each synchronous widget and embed the information into the screenshare or, alternatively, store the information, such that, for example, when the screenshare is requested, the synchronous widget is rendered in its current, real-time state, exactly as it appeared last time it was rendered in the screenshare on a computing device 10.

In an embodiment, the communication system 100 can include one or more controllers (not shown), including a high-speed controller that can manage bandwidth-intensive operations for the communication system 100, and a low-speed controller that can manage lower bandwidth-intensive operations. Such allocation of functions is exemplary only. In one implementation, the high-speed controller is coupled to a portion of the memory 120, the display screen (for example, through a graphics processor or accelerator), and to high-speed expansion ports (not shown), which can be arranged to accept various expansion cards (not shown). In the implementation, the low-speed controller is coupled to another portion of the memory 120 and one or more low-speed expansion ports (not shown). The low-speed expansion ports, which can include various communication ports (for example, USB) can be coupled to one or more input/output devices (not shown), such as a keyboard, a pointing device, a scanner, or a networking device such as a switch or router, for example, through a network adapter.

The communication system 100 can be implemented in a number of different forms, such as, for example, seen in FIGS. 1 and 2. For instance, it can be implemented as a server 30 (shown in FIG. 1), or multiple times in a group of such servers. It can also be implemented as part of a rack server system. In addition, it can be implemented in a personal computer such as a laptop computer. Alternatively, computing resource assets from the communication system 100 can be combined with other computing resource assets in a computing device 10. Each of such computing resource assets can contain one or more of the devices, and an entire system may be made up of multiple devices communicating with each other through communication links.

Referring to FIGS. 1 and 2, the communication system 100 can be arranged to communicate, for example, via the network 20, and to transmit a screenshare comprising one or more live AV content feeds (for example, AV-1, AV-2, AV-3, AV-4, AV-5, V1, or V2) to one or more computing devices 10 participating in a live share session. Using the GUI, the computing device 10, a participant can create, modify or manipulate a synchronous widget in the screenshare. The communication system 100 can monitor, capture, and record on-the-fly and in real-time, the creation, modification or manipulation of each synchronous widget, such that the synchronous widget can be rendered in its current, real-time state in the screenshare on each participant computing device 10.

The computing device 10 can be configured to reproduce the screenshare, including any live AV content feeds and any synchronous widgets, on its display device (shown in FIG. 1). For instance, the computing device 10 can be configured to display screenshare 300 (shown in FIG. 4), including live AV content feeds, 310, 320, 330, 340, 350, and the synchronous widget 360, in real-time; and, the participant (for example, using the stylus on the computing device, shown in FIG. 1) can manipulate the synchronous widget 360 on the display GUI to, for example, spin.

In a nonlimiting embodiment, the widget rendering file containing WCR instructions and WCR data (including, for example, UserID), can include markup language annotations for identifying content and creating structured documents or objects, including images, text, links, sounds, and other objects. The markup language annotations can include a plurality of tags for displaying widgets on the display screens of one or more of the computing devices 10 participating in the live share. The markup language can include, for example, Standard Generalized Markup Language (SGML), Scalable Vector Graphics (SVG), HTML, Extensible Markup Language (XHTML or XML), XML User Interface Language (XUL), or LaTeX. The markup language annotations can be provided as a markup language file that can be executed by, for example, a web browser running in the computing device 10 to render the synchronous widget, in its current real-time state, on the computing device 10. The widget rendering file can include the markup language file.

The annotations can include style sheet language annotations for providing rules for stylistics and for describing the presentation of the content and document with the markup language annotations, such as, for example, the markup language file. The style sheet language annotations can include, for example, colors, fonts, layouts, and other stylistic properties. The style sheet language can include, for example, CSS, Document Style Semantics and Specification Language (DSSSL), or Extensible Stylesheet Language (XSL). The style sheet language annotations can be provided as a style sheet language file. Alternatively, the style sheet language annotations can be incorporated into the file containing the markup language annotations.

The annotations can include scripting language instructions to create interactive effects related to the markup language annotations or style sheet language annotations. The scripting language can include, for example, Bash (for example, for Unix operating systems), ECMAScript (or JavaScript) (for example, for web browsers), Visual Basic (for example, for Microsoft applications), Lua, or Python. The scripting language instructions can include instructions that when executed by, for example, the web browser on the computing device 10 effect display or reproduction of a synchronous widget. The scripting language instructions can be provided as a scripting language file. Alternatively, the scripting language instructions can be incorporated into the file containing the markup language annotations.

The annotations can include a document object model (DOM) such as for HTML or XML (for example, DOM5 HTML) that can create object-oriented representations of the content or documents that can be modified with the scripting language instructions. A DOM includes a cross-platform and language-independent convention for representing and interacting with objects in HTML, XHTML/XML, SGML, SVG, or XUL. As used herein, a document can refer to the DOM's underlying document.

The annotations can be configured to be executable by the computing device 10 (shown in FIG. 1), or the processor 110 (shown in FIG. 2), and can follow a model-view-controller (MVC) design pattern for user interfaces. According to the MVC design pattern, an annotation can be divided into three areas of responsibility, including: (1) the Model, which includes the domain objects or data structures that represent the application's state; (2) the View, which observes the state and generates an output to the users; and, (3) the Controller, which translates user input into operations on the model.

The communication system 100 can be arranged to receive a screenshare request from a computing device 10 and provide the device with a screenshare, including a live AV content feed and any synchronous widgets. The screenshare, including any synchronous widgets, can be received from the communication system 100 by each computing device 10 participating in a live share session. The screenshare, including any synchronous widgets, can be reproduced by each participating computing device 10 by means of, for example, a browser application running on the computing device 10. The browser can, when executed by the computing device 10, convert, for example, HyperText Markup Language (HTML), Cascading Style Sheets and JavaScript into a working website, webpage or screenshare display that can be interacted with by an operator of the computing device 10, such as, for example, through a user interface. The screenshare can include, in addition to the synchronous widget, a source identifier for modification or manipulation of the synchronous widget, including the last, most-recent modification or manipulation.

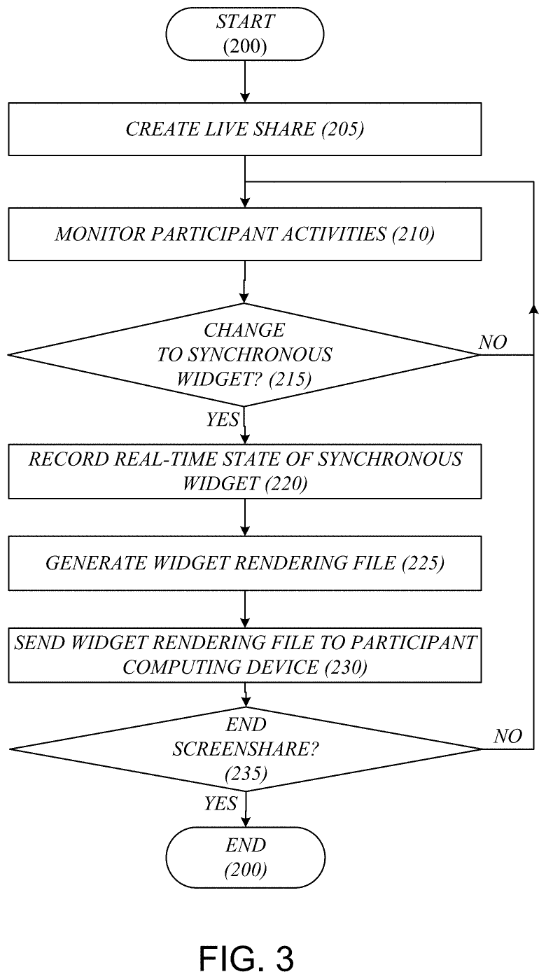

FIG. 3 shows an embodiment of a live share process 200 that can be performed by the communication system 100 (shown in FIG. 1 or 2). In an embodiment, the process 200 can be carried out by the processor 110 (shown in FIG. 2). In various embodiments, the communication system 100 (shown in FIG. 2), including processor 110, can be located in each computing device 10. Additionally, or alternatively, the communication system 100 can be provided separately from the computing devices 10, as seen in FIG. 1.

The memory 120 (shown in FIG. 2) can include a non-transitory computer-readable medium containing computer program instructions or executable code that, when executed by the processor 110, can cause the communication system 100 to perform each of the steps 205 to 235 of the process 200.

Referring to FIGS. 1-3 contemporaneously, a live share session can be initiated or created by the live share creator 160 in response to a request from a computing device 10, or sua sponte, such as, for example, at a scheduled time (Step 205).

In initiating or creating the live share session (Step 205), one or more live AV content feeds (for example, AV-1, AV-2, AV-3, AV-4, AV-5, shown in FIG. 1) can be received by the communication system 100 from respective one or more computing devices 10 (“participant computing devices”) and combined in a screenshare. The live share session can be hosted by the communication system 100, with each live AV content feed provided on a live share board in the screenshare (for example, screenshare 300, shown in FIG. 4).

The screenshare can include, for example, a background screen with alterable containers, each of which can be configured to render a live AV content feed from a unique participant computing device 10. In an embodiment, the screenshare can include, for example, a main screen similar to that of state-of-the art videoconference systems, except that the main screen can be configured to be rendered (or displayed) as near-infinite in width, height, or depth, such as, for example, limited only by the capabilities of the computer resource asset(s) in the communication system 100. In various embodiments, the screenshare can be configured to have any arrangement suitable for a particular live share session, as will be understood by those skilled in the art.

The communication system 100 can be configured to allow a participant computing device 10 to interact with (for example, create, modify or manipulate) any element or article in the screenshare, including a synchronous widget. For example, a participant computing device 10, via a user interface (for example, mouse, pointer, stylus, keyboard, keypad, or touchscreen) at the computing device 10, can receive commands from the associated participant to create, modify or move a synchronous widget anywhere in the screenshare, including, for example, flipping, turning, spinning, dragging, or otherwise altering a shape, location, size, appearance or characteristic of the synchronous widget on the screenshare.

In an embodiment, the screenshare can be arranged such that, when the screenshare is rendered on a participant computing device 10, the participant can (for example, using a mouse) move up, down, sideways, or into or away from any point or area on the screenshare, providing the participant with an experience of an infinitely wide, high or deep screenshare—for example, much like a person standing on the earth and being able to move in any direction with respect to the earth's surface, including, for example, forward, backward, sideways, down into the earth, or up and away from the surface.

The live share creator 160 can be arranged to assemble the live AV content feed from each participant computing device 10 to form the screenshare, including any synchronous widgets, in real-time, and feed the screenshare to each participant computing device 10, with the synchronous widget appearing it is current, real-time state. If any participant leaves the live share and returns to the screenshare at a later time, the synchronous widget will be rendered in its current, real-time state, including any modification or manipulation that was last made to the synchronous widget.

As the live share session proceeds in real-time, activities of each participant computing device 10 can be monitored in real-time, for example, by the PMU 172 (Step 210). At the same time, any synchronous widgets created, modified or manipulated by a participant can be monitored together with the details about the creation, modification or manipulation of the widget, for example, by the WMU 174, on-the-fly and detected and captured in real-time (Step 215). If creation of a synchronous widget, or modification or manipulation of an existing synchronous widget is detected (YES at Step 215), then the current, real-time state of the synchronous widget can be recorded (Step 220), otherwise (NO at Step 215) participant activities can be continued to be monitored (Step 210).

The current, real-time state of the synchronous widget can be used to generate a widget rendering file (Step 225), which can include WCR instructions and WCR data to render the synchronous widget in its current, real-time state. The widget rendering file can be sent to the participant computing devices 10 (Step 230). The widget rendering file can be included in the screenshare that is provided to the participant computing device 10, or in a separate communication to the each of the computing devices 10.

The screenshare renderer 180 can be configured to generate and send the widget rendering file, including the synchronous widget in its current real-time state. The screenshare renderer 180 can be configured to include all of the particulars of the synchronous widget as it currently exists, in real-time, including all characteristics and properties. The WCR data in the widget rendering file can include, for example, time, screen location, pixel color, pixel brightness, frequency, amplitude, timbre, velocity, wavelength, phase or any other visual or auditory characteristic of the synchronous widget as it exists in real-time.

A determination can be made whether the live share session is to end (Step 235), such as, for example, when all participant computing devices 10 have disconnected from the live share session. If it is determined that the live share has ended (YES at Step 235), then the process 200 can end, otherwise (NO at Step 235) the process can continue to monitor widget-related activities in the live share session (Step 210).

In an embodiment comprising HTML 5, the computer system 100 can be configured to provide, for example, an audio tag (for example, an instruction to embed an audio file or link in the displayed screen and how to play it), a video tag (for example, an instruction to embed video in the displayed screen and how to play it), a source tag (for example, can be used with audio or video to identify a source for the audio or video), an embed tag (e.g., an instruction to embed specified media type for content that might lack support within other media elements), a canvas tag (for example, an instruction to set aside part of the display screen), and an svg tag (for example, an instruction to embed vector graphics (for example, object, text, overlay and/or background) encoded with SVG markup language, to allow graphics (for example, objects, text, overlay and/or background) to be scaled dynamically to the area and shape of the display screen without losing any graphic quality). As understood by those skilled in the art, other tags can be included that, when referenced by, for example, a style sheet language, cause the communicating device 10 to render the synchronous widget in its current, real-time state, including for example, current location, layout, size, shape, color, texture, font, special effect, backdrop, or any other visual or auditory characteristic.

The terms “a,” “an,” and “the,” as used in this disclosure, mean “one or more,” unless expressly specified otherwise.

The terms “annotate,” “annotating,” “annotated,” and variations thereof, as used in this disclosure, mean to draw on, mark up, alter or manipulate live AV content as it appears or, in the case of audio content, is reproduced in real-time on one or more computing devices during live share of AV content by one computing device, or between two or more computing devices.

The term “annotation,” as used in this disclosure, means a line, a circle, an object, an article, a drawing, a mark, a special effect, or anything else that can be applied, superimposed, added or incorporated into live AV content in real-time during a live share.

The term “backbone,” as used in this disclosure, means a transmission medium that interconnects one or more computing devices or communicating devices to provide a path that conveys data signals and instruction signals between the one or more computing devices or communicating devices. The backbone can include a bus or a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The term “communication device,” “communicating device,” or variations thereof, as used in this disclosure, means any hardware, firmware, or software that can transmit or receive data packets, instruction signals, data signals or radio frequency signals over a communication link. The communicating device can include a computer or a server. The communicating device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 302.11, DECT, 0G, 1G, 2G, 3G, 4G, 5G, or 6G cellular standards, or Bluetooth. A communication link can include, for example, an RS-232, RS-422, RS-485, or any other suitable serial interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a processor, a microprocessor (μC), a central processing unit (CPU), a graphic processing unit (GPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The terms “computing resource” or “computer resource,” as used in this disclosure, means software, a software application, a web application, a web page, a computer application, a computer program, computer code, machine executable instructions, firmware, or a process that can be arranged to execute on a computing device as one or more computing resource processes.

The term “computing resource process,” as used in this disclosure, means a computing resource that is in execution or in a state of being executed on an operating system of a computing device. Every computing resource that is created, opened or executed on or by the operating system can create a corresponding “computing resource process.” A “computing resource process” can include one or more threads, as will be understood by those skilled in the art.

The terms “computer resource asset” or “computing resource asset,” as used in this disclosure, means a computing resource, a computing device or a communicating device, or any combination thereof.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 302.11, DECT, 0G, 1G, 2G, 3G, 4G, or 5G cellular standards, or Bluetooth.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can include a database management system application (DBMS). The at least one application may include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and their variations, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The term “transmission,” “transmit,” “sent” or “send,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

What is claimed is:

1. A communication system that initiates and maintains a screenshare comprising live audio-video (AV) content from one or more participant computing devices in a live share session, the system comprising:
a receiver configured to receive a live audio-video content feed from a first participating computing device;
a processor configured to:
initiate, by a live share creator, a live share session that includes the live audio-video content feed from the first participating computing device and a widget;
generate a screenshare, by a screenshare renderer, containing the audio-video content feed from the first participating computing device and the widget;
detect, by a widget state monitor, in real time any interaction with the widget; and
when an interaction with the widget occurs, record, by the widget state monitor, details of the interaction including a current real-time state of the widget;
a transmitter configured to send the screenshare, including the live audio-video content feed from the first participating computing device, and a synchronous widget to a second participating computing device,
wherein the synchronous widget includes the details of the interaction, including the current real-time state of the widget, and
wherein the synchronous widget is maintained persistently regardless of any interruption in the live share session.

2. The communication system in claim 1, further comprising:
a widget generating tool configured to generate the widget, wherein the widget is configured to interact with the first computing device or the second computing device.

3. The communication system in claim 1, further comprising:
a screenshare renderer configured to generate the screenshare based on the synchronous widget and video content contained in the live audio-video content feed from the first participating computing device.

4. The communication system in claim 3, wherein the screenshare renderer is configured to communicate and interact with the transmitter to:
assemble the synchronous widget and the video content into a video screenshare;
packetize the video screenshare; and
send the packetized video screenshare to the second participating computing device.

5. The communication system in claim 3, wherein the screenshare renderer includes a translator configured to translate the video content or audio content contained in the live audio content feed from a first format or language to a second format or language used by the second participating computing device.

6. The communication system in claim 1, wherein the interruption in the live share session comprises the first computing device disconnecting from the live share session and reconnecting at a later time.

7. The communication system in claim 6, wherein the first computing device is provided with the synchronous widget when reconnecting at a later time.

8. A computer-implemented method for initiating and maintaining a screenshare comprising live audio-video (AV) content from one or more participant computing devices in a live share session, the method comprising:
receiving a live audio-video content feed from a first participating computing device;
initiating, by a live share creator, a live share session that includes the live audio-video content feed from the first participating computing device and a widget;
generating a screenshare, by a screenshare renderer, containing the audio-video content feed from the first participating computing device and the widget;
detecting, by a widget state monitor, in real time any interaction with the widget;
when an interaction with the widget occurs, recording, by the widget state monitor, details of the interaction including a current real-time state of the widget; and
transmitting the screenshare, including the live audio-video content feed from the first participating computing device, and a synchronous widget to a second participating computing device,
wherein the synchronous widget includes the details of the interaction, including the current real-time state of the widget, and
wherein the synchronous widget is maintained persistently regardless of any interruption in the live share session.

9. The computer-implemented method in claim 8, further comprising:
generating the widget by a widget generating tool configured such that the widget interacts with a graphic user interface of the first computing device or the second computing device.

10. The computer-implemented method in claim 8, further comprising:
generating the screenshare based on the synchronous widget and video content contained in the live audio-video content feed from the first participating computing device.

11. The computer-implemented method in claim 10, further comprising:
assembling the synchronous widget and the video content into a video screenshare;
packetizing the video screenshare; and
sending the packetized video screenshare to the second participating computing device.

12. The computer-implemented method in claim 10, further comprising:
translating the video content or audio content contained in the live audio content feed from a first format or language to a second format or language used by the second participating computing device.

13. The computer-implemented method in claim 8, wherein the interruption in the live share session comprises the first computing device disconnecting from the live share session and reconnecting at a later time.

14. The computer-implemented method in claim 13, wherein the first computing device is provided with the synchronous widget when reconnecting at a later time.

15. A non-transitory computer-readable medium for initiating and maintaining a screenshare comprising live audio-video (AV) content from one or more participant computing devices in a live share session, the computer-readable medium comprising instructions that, when executed by a processor, cause the processor to perform a method comprising:
receiving a live audio-video content feed from a first participating computing device;
initiating, by a live share creator, a live share session that includes the live audio-video content feed from the first participating computing device and a widget;
generating a screenshare, by a screenshare renderer, containing the audio-video content feed from the first participating computing device and the widget;
detecting, by a widget state monitor, in real time any interaction with the widget;
when an interaction with the widget occurs, recording, by the widget state monitor, details of the interaction including a current real-time state of the widget; and
transmitting the screenshare, including the live audio-video content feed from the first participating computing device, and a synchronous widget to a second participating computing device,
wherein the synchronous widget includes the details of the interaction, including the current real-time state of the widget, and
wherein the synchronous widget is maintained persistently regardless of any interruption in the live share session.

16. The non-transitory computer-readable medium in claim 15, wherein the method further comprises:
generating the widget by a widget generating tool configured such that the widget interacts with a graphic user interface of the first computing device or the second computing device.

17. The non-transitory computer-readable medium in claim 15, wherein the method further comprises:
generating the screenshare based on the synchronous widget and video content contained in the live audio-video content feed from the first participating computing device.

18. The non-transitory computer-readable medium in claim 17, wherein the method further comprises:
assembling the synchronous widget and the video content into a video screenshare;
packetizing the video screenshare; and
sending the packetized video screenshare to the second participating computing device.

19. The non-transitory computer-readable medium in claim 17, wherein the method further comprises:
translating the video content or audio content contained in the live audio content feed from a first format or language to a second format or language used by the second participating computing device.

20. The non-transitory computer-readable medium in claim 15, wherein the interruption in the live share session comprises the first computing device disconnecting from the live share session and reconnecting at a later time.
